(19) United States
(12) Patent Application Publication
(10) Pub. No.: US 2020/0031293 A1
(43) Pub. Date: Jan. 30, 2020

(54) LICENSE PLATE SUPPORT ASSEMBLY

(71) Applicant: Harley-Davidson Motor Company Group, LLC, Milwaukee, WI (US)

(72) Inventors: Carissa Jo Conine, Milwaukee, WI (US); Steven Wade Osgood, Campbellsport, WI (US)

(21) Appl. No.: 16/519,995

(22) Filed: Jul. 23, 2019

Related U.S. Application Data
(60) Provisional application No. 62/711,849, filed on Jul. 30, 2018.

(51) Int. Cl. B60R 13/10; B60Q 1/26; G09F 7/18; B60Q 1/38

(52) U.S. Cl. CPC B60R 13/105; B60Q 1/2661; G09F 2007/1895; B60Q 1/38; G09F 2007/1865; G09F 7/18

(57) ABSTRACT

A license plate support assembly includes a main bracket defining a license plate support surface. First and second turn signal assemblies include respective electrically-actuatable turn signals and are coupled to the main bracket and positioned alongside respective first and second lateral sides of the license plate support surface. At least one of the first and second turn signal assemblies is adjustably mounted with respect to the main bracket to accommodate license plates of different widths.

### CROSS-REFERENCE TO RELATED APPLICATIONS

This application claims priority to U.S. Provisional Patent Application No. 62/711,849, filed Jul. 30, 2018, the entire contents of which are incorporated by reference herein.

### BACKGROUND

The present invention relates to vehicle license plate brackets and more specifically to arrangements of turn signals and license plate brackets for a motorcycle.

### SUMMARY

In one aspect, the invention provides a license plate support assembly for a vehicle. The license plate support assembly includes a main bracket defining a license plate support surface. First and second turn signal assemblies include respective electrically-actuatable turn signals and are coupled to the main bracket and positioned alongside respective first and second lateral sides of the license plate support surface. At least one of the first and second turn signal assemblies is adjustably mounted with respect to the main bracket to accommodate license plates of different widths.

In another aspect, the invention provides a license plate support assembly for a vehicle. The license plate support assembly includes a main bracket defining a license plate support surface. A first turn signal is supported from the main bracket by a first turn signal bracket so that the first turn signal is positioned on a first side of the license plate support surface, and a second turn signal is supported from the main bracket by a second turn signal bracket so that the second turn signal is positioned on a second side of the license plate support surface. Inboard and outboard mounting positions are provided for each one of the first and second turn signal brackets with respect the main bracket so as to provide a variable spacing distance between the first and second turn signals.

In yet another aspect, the invention provides a method of adjusting a vehicle license plate support assembly having first and second integral turn signals. The license plate support assembly is provided in a first configuration in which the first and second turn signals are mounted in respective first positions on laterally-opposed sides of a main bracket of the license plate support assembly that defines a license plate support surface, wherein a first spacing distance between the first and second turn signals is defined. A first turn signal bracket supporting the first turn signal is loosened from the main bracket. The first turn signal bracket is laterally adjusted to a second position that provides a second spacing distance, different from the first spacing distance, between the first and second turn signals. The first turn signal bracket is secured to the main bracket in the second position.

### BRIEF DESCRIPTION OF THE DRAWINGS

FIG. 1 is a side view of a vehicle, as shown, a motorcycle.

FIG. 2 is a perspective view of a rear portion of a vehicle.

FIG. 3 is a perspective view of a license plate bracket mounted to the rear portion of the vehicle shown in FIG. 1, where the license plate bracket is in a first arrangement.

FIG. 4 is a perspective view of a license plate bracket mounted to the rear portion of the vehicle shown in FIG. 1, where the license plate bracket is in a second arrangement.

FIG. 5 is a perspective view of a license plate bracket mounted to the rear portion of the vehicle shown in FIG. 1, where the license plate bracket is in a third arrangement.

FIG. 6 is a front view of the rear of the license plate bracket in the first arrangement, viewing from the perspective of the rear wheel.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

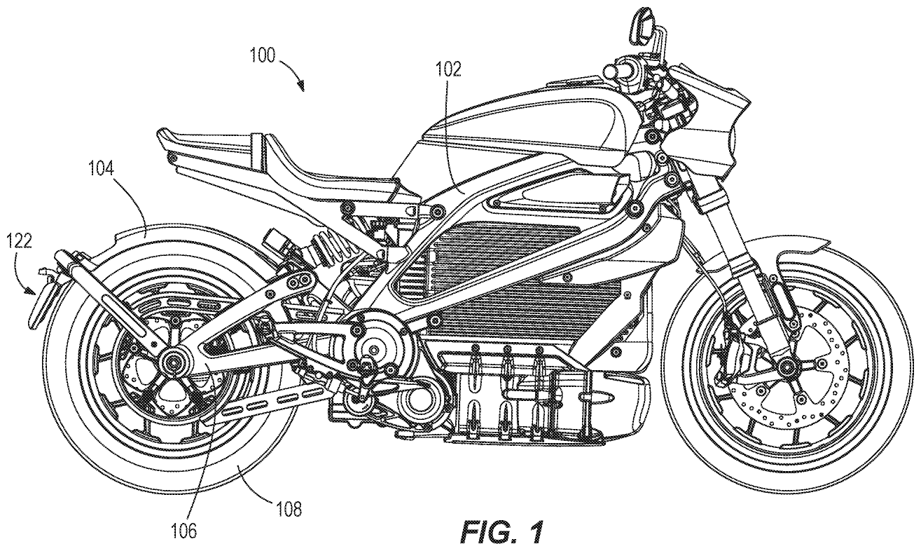

FIG. 1 illustrates a vehicle 100 having a frame 102 and a plurality of body panels. A swing arm 106 is attached to the frame 102 and defines a rotational axis for a rear wheel 108 of the vehicle 100. One of the body panels is a rear fender 104 that extends above and partially around the rear wheel 108 (including a wheel/rim and a tire). The rear fender 104 is attached to and supported by the swing arm 106.

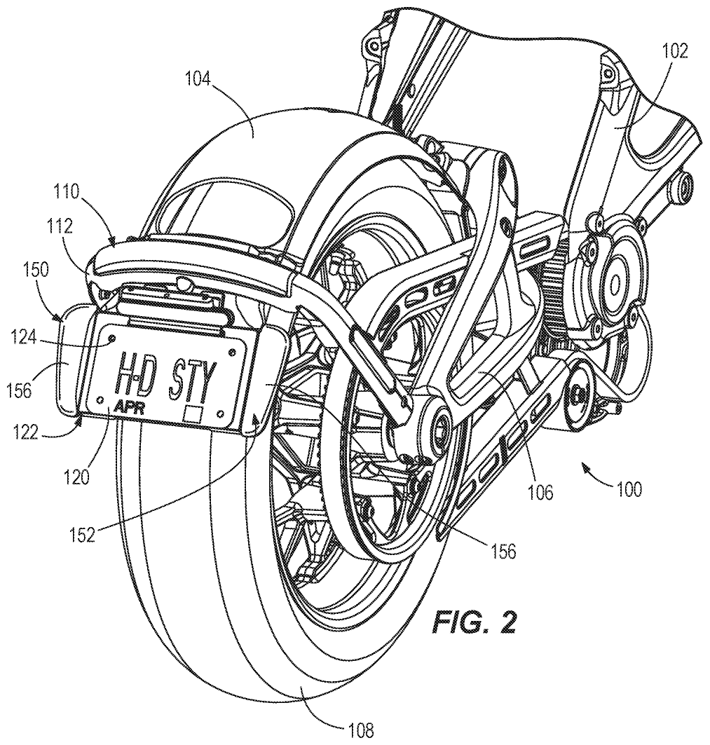

FIG. 2 illustrates a rear portion of the vehicle 100. While the vehicle 100 is shown as a motorcycle, the vehicle can otherwise be embodied as another saddle-ridden vehicle such as an all-terrain vehicle, a recreational off-highway vehicle, a snowmobile, a scooter, a moped, or a bicycle. The vehicle 100 may otherwise be another automobile (car, truck, etc.) where the body panel 104 forms part of a body of the automobile that at least substantially encloses the driver within the vehicle.

The vehicle 100 includes a taillight 110 mounted to the frame 102 via a taillight bracket 112. The taillight bracket 112, as shown, is fixed to the swing arm 106, provides a mount for securing a rear end of the rear fender 104, and extends around the rear wheel 108. The taillight 110 can operate in a first mode with a first intensity as a taillight and in a second mode with greater intensity to indicate a braking action and an associated decrease in speed of the vehicle 100 (e.g., by the vehicle operator) to other individuals (such as other motorists) located behind the vehicle 100.

Certain vehicles 100 may require a license plate 120 (also known as a number plate or vehicle registration plate) to uniquely identify the vehicle 100 or owner/operator within a jurisdiction or region's register. The license plate 120 is fastened to the rear of the vehicle 100 and is displayed such that the numeric or alphanumeric characters on the license plate 120 are visible from behind the vehicle 100. The width of the license plate 120 can vary from one jurisdiction to another, and can further vary based on the type of vehicle. For example, motorcycle license plates in the United States have a standardized width of 7 inches (180 mm), while in Germany a motorcycle license plate has a standardized width of roughly 9.5 (240 mm) inches.

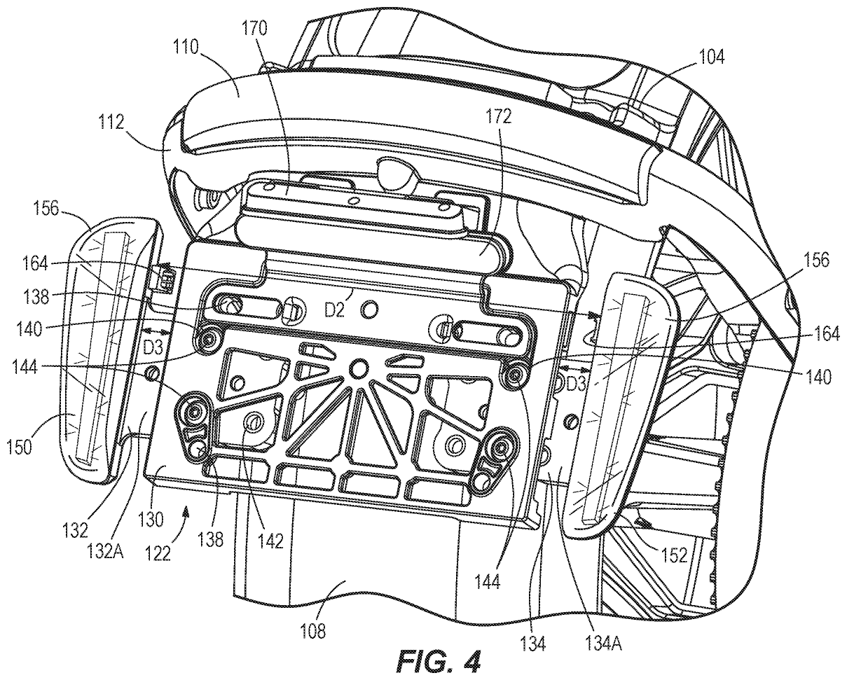

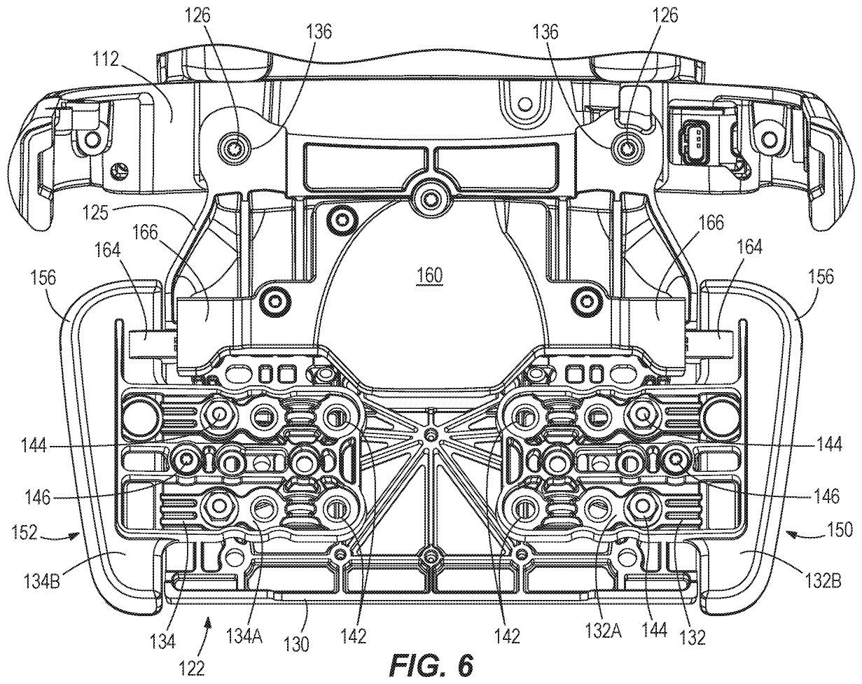

As shown in FIG. 2, the license plate 120 is attached to an adjustable license plate support 122 via a plurality of fasteners 124 (e.g., threaded fasteners) that extend through the license plate 120 and apertures 138 in the license plate support 122 (FIG. 4). As best shown in FIG. 6, the license plate support 122 has a vehicle mount portion 125 that is attached to the taillight bracket 112 via additional fasteners 126 (e.g., threaded fasteners). Alternatively, the license plate support 122 may be attached to the swing arm 106 of the vehicle 100 or to the rear fender 104 or another body panel of the vehicle 100.

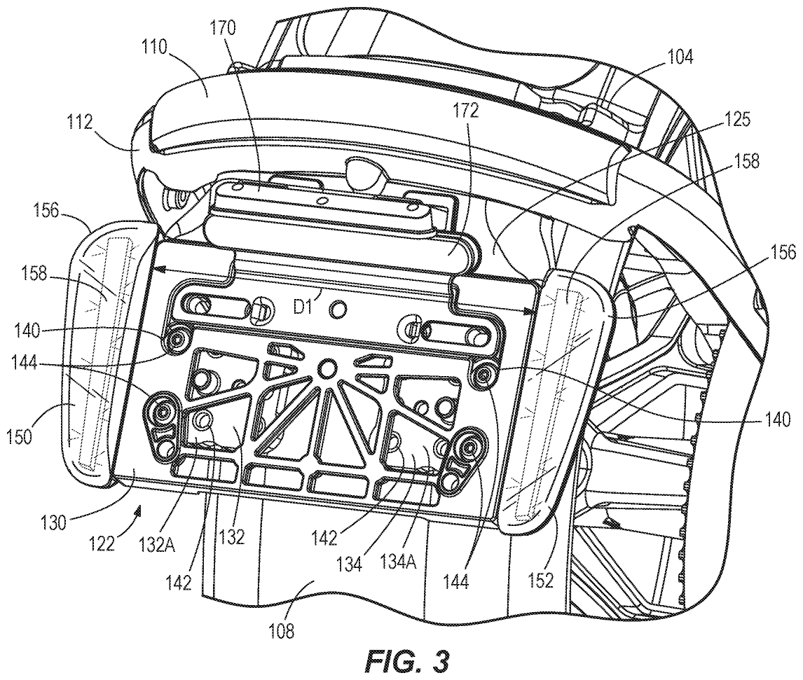

As shown in FIGS. 3-5, the license plate support 122 includes three brackets: a first bracket 130, a second bracket 132, and a third bracket 134. The first bracket 130 is a central bracket and includes mounting apertures 136 through which the fasteners 126 couple the license plate support 122 to the vehicle 100, as described above. Therefore, when the fasteners 126 couple the first bracket 130 to the vehicle 100, the first bracket 130 is fixed relative to the vehicle 100 or relative to a frame 102 or body panel 104 of the vehicle. Further still, the first bracket 130 may be integrally formed as a single piece with one of the vehicle body panels.

The first bracket 130 also includes license plate mounting apertures 138 through which the fasteners 124 extend to couple the license plate 120 to the license plate support 122. The first bracket 130 further includes turn signal mounting apertures 140, through which the second and third brackets 132, 134 are coupled to the first bracket 130.

The second and third brackets 132, 134, as shown best in FIGS. 3-6, are coupled to the first bracket 130 via fasteners 144 (e.g., threaded fasteners, rivets, etc.) that extend through the turn signal mounting apertures 140 in the first bracket and mating apertures 142 in the respective second and third brackets 132, 134. Further, an additional fastener 146 (FIG. 6) may extend through the first bracket 130 and one or both of the second and third brackets 132, 134 in an opposing direction to the fasteners 144. The second and third brackets 132, 134 each include a first portion 132A, 134A that at least partially extends behind the first bracket 130, is substantially planar, and includes the mating apertures 142 for attaching to the first bracket 130. The second and third brackets 132, 134 further include respective second portions 132B, 134B that support an electrically actuated turn signal 150, 152. The second bracket 132 supports a left turn signal 150 that is actuated to signal the intention of moving the vehicle to the left (i.e., making a left turn, changing lanes to the left). The third bracket 134 supports a right turn signal 152 that is actuated to signal the intention of moving the vehicle to the right (i.e., making a right turn, changing lanes to the right).

The second portions 132B, 134B of the brackets 132, 134 that extend behind the turn signals 150, 152 each attach to a lens 156 that, together with the respective second portion 132B, 134B, surrounds a light source 158 (FIG. 3) such as an incandescent bulb or an LED. The lens 156 and light source 158 can extend vertically along the entire license plate support area such that the height of the lens 156 is substantially equal to the height of the license plate support 122 and/or the license plate 120. The second portions 132B, 134B of the respective brackets 132, 134 may be made of an opaque material to prevent light from passing therethrough. The lens 156 may be formed of a different material than the second portions 132B, 134B, such as a transparent or translucent material to allow light from the light source 158 to pass therethrough such that another driver can view the blinking of the turn signal light 158 from behind the vehicle 100.

When the second and third brackets 132, 134 are attached to the first bracket 130 via the fasteners 144, the second portions 132B, 134B of the second and third brackets 132, 134 are positioned about the lateral edges of the first bracket 130 such that the turn signals 150, 152 are visible from behind the vehicle 100 (i.e., not covered by the first bracket 130 or by a license plate 120 mounted to the first bracket 130).

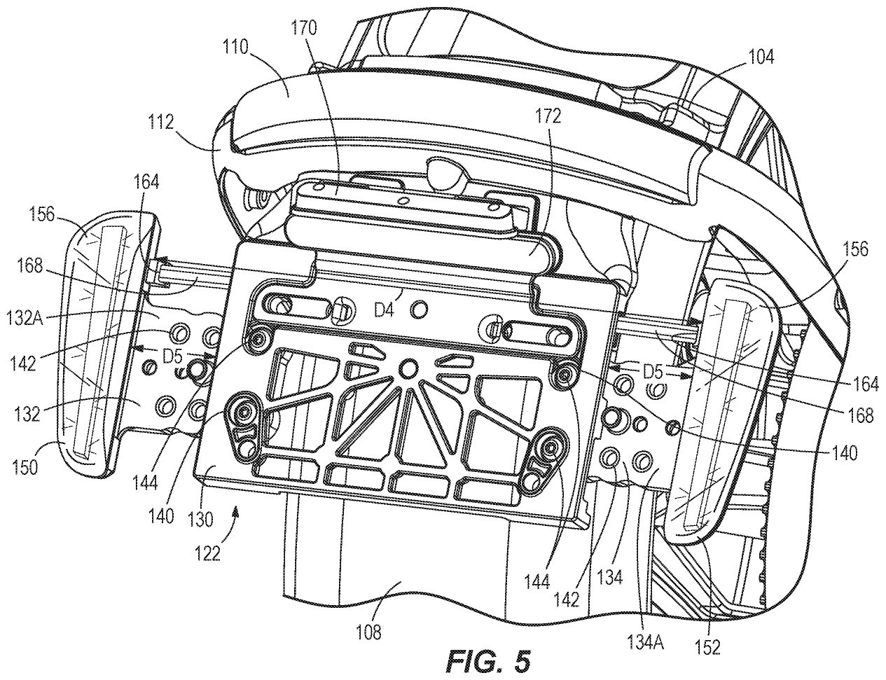

The turn signals 150, 152 are also electrically coupled to the first bracket 130, or to an electrical housing 160 (FIG. 6) mounted to the first bracket 130. Each of the second and third brackets 132, 134 includes an electrical connector 164 (FIGS. 4-6) that is connected to a mating connector 166 on the rear of the first bracket 130. The connection between the connectors 164, 166 may be direct such that one of the connectors 164, 166 is received within the other. Alternatively, the electrical connectors 164, 166 may be connected via a separate electrical connector 168 (e.g., a cable, wire(s), or another intermediate extension device) therebetween as shown in FIG. 5. In some constructions, the separate electrical connector 168 accommodates various positions of the second and third brackets 132, 134, thus being used for vehicles manufactured for use in multiple jurisdictions. In other constructions, the separate electrical connector 168, or an alternate connector 164 and/or 166, may be used for vehicles manufactured for selected jurisdictions—those having wider license plate dimensions. Further still, the first bracket 130 (or an electrical housing 160 mounted thereto) may not be provided with connectors 166 and the electrical connectors 164 of the second and third brackets 132, 134 may be connected via wiring directly to a controller. The connectors 164, 166 provide electricity to the turn signals 150, 152 to actuate the light source 158 when activated by the vehicle operator.

The license plate support 122 may further be provided with additional electrical components such as a license plate light 170 for illuminating the license plate at night or in inclement weather. Further, a secondary brake light or reflector 172 mounted to the support 122 may provide an additional indication of braking (if electrically actuated) or may otherwise reflect the lights of other vehicles as further illumination of the vehicle at night or in inclement weather.

As shown in FIGS. 3-5, the license plate support 122 can be assembled in a plurality of different positions to accommodate license plates 120 of different widths without covering the turn signals 150, 152 attached thereto and allowing the turn signals 150, 152 to directly flank license plates 120 of various sizes. FIG. 3 illustrates the second and third brackets 132, 134 attached to the first bracket 130 at a first position where the distance D1 between the turn signals 150, 152 is minimized as the turn signals 150, 152 abut the first bracket 130 (or nearly abut the first bracket, as permitted by the electrical connection). The space between the turn signals 150, 152 is able to accommodate a license plate 120 of a first, narrow width. In the first position, the fasteners 144 extend through the apertures 140 in the first bracket 130 (FIG. 3) and through first mating apertures 142 in the second and third brackets 132, 134 (FIG. 6). When in the first position, the electrical connectors 164 are inserted into the mating connectors 166 to provide electrical power to the turn signals 150, 152.

FIG. 4 illustrates the second and third brackets 132, 134 attached to the first bracket 130 at a second position where the distance D2 between the turn signals 150, 152 is greater than the distance D1 as the turn signals 150, 152 are spaced apart from the first bracket 130 by a distance D3 to accommodate a license plate 120 of a second width. In the second position, the fasteners 144 extend through the apertures 140 in the first bracket 130 and through second mating apertures 142 in the second and third brackets 132, 134. When in the second position, the electrical connectors 164 are spaced apart from the mating connectors 166, though the gap therebetween can be bridged by the electrical connector 168.

FIG. 5 illustrates the second and third brackets 132, 134 attached to the first bracket 130 at a third position where the distance D4 between the turn signals 150, 152 is greater than the distances D1 and D2 as the turn signals 150, 152 are spaced apart from the first bracket 130 by a distance D5 to accommodate a license plate 120 of a third, larger width. In the third position, the fasteners 144 extend through the apertures 140 in the first bracket 130 and through third mating apertures 142 in the second and third brackets 132, 134. When in the third position, the electrical connectors 164 are spaced apart from the mating connectors 166, though, similar to the second position, the gap therebetween can be bridged by the electrical connector 168 and the connection between the connectors still provides electrical power to the turn signals 150, 152. The difference between D1 and D4 can define an overall range of adjustment for the pair of turn signals 150, 152, and in some constructions this range can be over 40 mm (e.g., at least 60 mm).

It is described that the second and third brackets 132, 134 include multiple apertures 142 that can be aligned with a single aperture 140 (for each bracket 132, 134) in the first bracket 130. In other embodiments, the second and third brackets 132, 134 can be provided with a single aperture that can be aligned with multiple apertures in the first bracket 130. In still other embodiments, each of the first, second, and third brackets 130, 132, 134 can include multiple apertures to provide a larger variance of mounting positions of the second and third brackets 132, 134 relative to the first bracket. In still further embodiments, one of the turn signals 152 may be fixed to the first bracket such that it is not adjustable between a plurality of positions, and only one of the second and third brackets 132, 134 is adjustable relative to the first bracket 130.

With respect to the claims below, numbers such as “first,” “second,” and “third” within the specification and claims are used for differentiating components, positions, and distances and do not denote an order unless otherwise described.

While some vehicles and some jurisdictions only require a rear license plate, it is to be understood that the license plate support 122 as described herein can likewise be applied to a front of a vehicle as a license plate bracket for a front license plate.

What is claimed is:

1. A license plate support assembly for a vehicle, the license plate support assembly comprising:
a main bracket defining a license plate support surface;
a first turn signal assembly including an electrically-actuatable turn signal, the first turn signal assembly being coupled to the main bracket and positioned alongside a first lateral side of the license plate support surface; and
a second turn signal assembly including an electrically-actuatable turn signal, the second turn signal assembly being coupled to the main bracket and positioned alongside a second lateral side of the license plate support surface,
wherein at least one of the first and second turn signal assemblies is adjustably mounted with respect to the main bracket to accommodate license plates of different widths.

2. The license plate support assembly of claim 1, wherein a bracket of the first turn signal assembly is attachable to the main bracket at two different relative positions, providing an inboard mounting position and an outboard mounting position.

3. The license plate support assembly of claim 2, wherein a bracket of the second turn signal assembly is attachable to the main bracket at two different relative positions, providing an inboard mounting position and an outboard mounting position.

4. The license plate support assembly of claim 2, further comprising an electrical connection electrically coupled to the turn signal of the first turn signal assembly, the electrical connection being maintained in both the first and second positions.

5. The license plate support assembly of claim 2, wherein one of the main bracket and the bracket of the first turn signal assembly includes a plurality of mounting apertures arranged in a row for selective alignment with a mounting aperture of the other of the main bracket and the bracket of the first turn signal assembly.

6. The license plate support assembly of claim 3, wherein the bracket of each of the first and second turn signal assemblies includes multiple sets of mounting apertures for attachment with the main bracket.

7. The license plate support assembly of claim 1, wherein the main bracket includes a plurality of apertures for mounting a license plate thereto.

8. The license plate support assembly of claim 1, further comprising a license plate illumination device mounted to the main bracket and operable to illuminate a license plate on the license plate support surface of the main bracket.

9. The license plate support assembly of claim 1, wherein the main bracket includes a vehicle mount portion extending from the license plate support surface for attachment with a rear portion of the vehicle.

10. A license plate support assembly for a vehicle, the license plate support assembly comprising:
a main bracket defining a license plate support surface;
a first turn signal supported from the main bracket by a first turn signal bracket so that the first turn signal is positioned on a first side of the license plate support surface; and
a second turn signal supported from the main bracket by a second turn signal bracket so that the second turn signal is positioned on a second side of the license plate support surface,
wherein inboard and outboard mounting positions are provided for each one of the first and second turn signal brackets with respect the main bracket so as to provide a variable spacing distance between the first and second turn signals.

11. The license plate support assembly of claim 10, wherein the first and second turn signals are positioned adjacent the first and second sides of the license plate support surface, respectively, in the respective inboard mounting positions such that adjustment of the first and second turn signals to the respective outboard mounting positions increases the available width for a license plate on the license plate support surface.

12. The license plate support assembly of claim 10, wherein an additional intermediate mounting position is provided for each one of the first and second turn signal brackets with respect to the main bracket.

13. The license plate support assembly of claim 10, further comprising a first electrical connection electrically coupled to the first turn signal, and a second electrical connection electrically coupled to the second turn signal, the first and second electrical connections being maintained in both the inboard and outboard mounting positions.

14. The license plate support assembly of claim 10, wherein a plurality of mounting apertures are arranged in a row on either the main bracket or the first and second turn signal brackets to provide the inboard and outboard mounting positions.

15. The license plate support assembly of claim 10, wherein each of the first and second turn signal brackets includes multiple sets of mounting apertures for alignment with a corresponding mounting aperture in the main bracket.

16. The license plate support assembly of claim 10, wherein the main bracket includes a plurality of apertures for mounting a license plate thereto.

17. The license plate support assembly of claim 10, further comprising a license plate illumination device mounted to the main bracket and operable to illuminate a license plate on the license plate support surface of the main bracket.

18. The license plate support assembly of claim 10, wherein the main bracket includes a vehicle mount portion extending from the license plate support surface for attachment with a rear portion of the vehicle.

19. A method of adjusting a vehicle license plate support assembly having first and second integral turn signals, the method comprising:
providing the license plate support assembly in a first configuration in which the first and second turn signals are mounted in respective first positions on laterally-opposed sides of a main bracket of the license plate support assembly that defines a license plate support surface, wherein a first spacing distance between the first and second turn signals is defined;
loosening a first turn signal bracket supporting the first turn signal from the main bracket;
laterally adjusting the first turn signal bracket to a second position that provides a second spacing distance, different from the first spacing distance, between the first and second turn signals; and
securing the first turn signal bracket to the main bracket in the second position.

20. The method of claim 19, further comprising;
loosening a second turn signal bracket supporting the second turn signal from the main bracket;
laterally adjusting the second turn signal bracket to a second position that provides a third spacing distance, different from the first and second spacing distances, between the first and second turn signals; and
securing the second turn signal bracket to the main bracket in the second position.
